(19) United States
(12) Patent Application Publication
(10) Pub. No.: US 2020/0055452 A1
(43) Pub. Date: Feb. 20, 2020

(54) RECORDING DEVICE INCLUDING MOBILE PHONE, CAMERA LENS CAPABLE OF RESOLVING BLIND SPOT (BLIND AREA) OF ELETRIC VEHICLE, MONITOR AND SENSOR FLASHING LIGHT

(71) Applicant: Chi Hong YEO, Anyang-si (KR)

(72) Inventor: Chi Hong YEO, Anyang-si (KR)

(21) Appl. No.: 16/347,174

(22) PCT Filed: Nov. 6, 2017
(86) PCT No.: PCT/KR2017/012473

§ 371 Date: May 2, 2019

(30) Foreign Application Priority Data
Nov. 3, 2016 (KR) 10-2016-0145810

(51) Int. Cl. B60R 1/00; B60Q 1/34; B60Q 9/00; B60R 11/04; G07C 5/06

(52) U.S. Cl. CPC B60R 1/00; B60Q 1/34; B60R 2011/004; B60R 11/04; G07C 5/06; B60Q 9/008

(57) ABSTRACT

Methods and systems are described for resolving a blind spot in a side-view mirror of a vehicle and for determining, in the event of an accident during a lane change, who is at fault by recording the surrounding situation to a recording device. Instead of a side-view mirror, a mobile phone camera lens is installed near where a headlight is installed approximately one meter in front of the position of conventional side-view mirrors. Monitors are installed to the left and right of the vehicle dashboard. When the left and right side monitors are connected to the mobile phone camera lenses through a cable, the same background as a rearview background seen through the mobile phone camera lens can be seen on the monitors, thereby allowing a driver to see, through the monitors installed inside the vehicle, transparent rear left and right backgrounds having wide ranges and absent of blind spots.

### TECHNICAL FIELD

The present invention relates to a recording device for eliminating blind spots generated when viewing the rear side through side-view mirrors mounted on left and right sides in a typical vehicle and identifying the presence of a fault from video images stored in a recording device in order to determine who is at fault in a traffic accident by recording all situations around the vehicle in the recording device, more particularly, to provision of a recording device including a camera lens for mobile phones, a monitor and a sensor flasher, which are integrally mounted in an electric vehicle in order to eliminate blind spots.

### BACKGROUND ART

The present invention relates to a recording device consisting of a camera lens for mobile phones (‘mobile phone camera lens’), a monitor and a sensor flasher, which are integrally mounted in an electric vehicle, in order to eliminate blind spots, so that a driver may drive safely during traveling or lane change and have a correct driving habit. Further, in order to determine who is at fault in a collision accident, the recording device of the present invention is characterized in that: instead of a typical side-view mirror, the mobile phone camera lens is installed near a site where a headlamp is mounted and which is spaced by 1.00 m in front of a site where the side-view mirror is mounted; and monitors are installed on left and right sides of a dashboard in the vehicle, wherein the mobile phone camera lens is connected to the monitors on the left and right sides by a cable, thereby enabling a driver to see the same background as a rear view projected through the mobile phone camera lens from the monitors. Therefore, the driver can have a rear view without blind spots through the monitors. In addition to the mobile phone camera lens and the monitors installed on the left and right sides of the vehicle dashboard, sensor flashers are mounted on the left and right sides of the vehicle and connected to the above components through cables, thereby recording all situations occurring around the vehicle.

In the existing vehicle, only a rear view at about 35° can be seen through a side-view mirror. However, according to the present invention, instead of such a side-view mirror, a mobile phone camera lens is used and, when moving the camera lens forward by a distance of about 1.00 M, it is possible to ensure a clear rear view field at an angle of about 60°, which is higher than the previous angle.

Reasons for installing the mobile phone camera lens in the present invention, instead of the side-view mirror mounted on the existing vehicle, are as follows.

First, in order to eliminate blind spots and ensure a wider rear view field, the mobile phone camera lens may be integrally installed in an electric vehicle, thereby facilitating safe driving.

Second, the mobile phone camera lens may have a minimized cross-sectional area, compared to the typical side-view mirror, so as to considerably reduce wind resistance, thereby maximizing driving effects.

Third, the existing vehicle could not have a clear rear view in the rain since the side-view mirror is wet with rainwater, whereas the present invention may ensure a clear rear view through the monitors installed inside the vehicle to thus accommodate safe driving.

As such, the present invention may satisfy the above conditions. More particularly, in case of changing lanes, turn signal lamps mounted on front, rear, left and right sides as well as the sensor flashers installed on the left and right sides of the vehicle are turned on simultaneously in a direction to progress. Further, when other vehicles traveling in left and right sides (or in adjacent lanes) of the vehicle are within a dangerous traveling range, danger indication and warning signals are generated on the monitor and, at the same time, all situations are recorded in the recording device, so that a driver may determine who is at fault based on video images stored in the recording device if a collision accident occurs during traveling or lane change, thereby enabling the driver to have proper driving habits and preventing collision accidents from occurring during traveling.

The side-view mirror in the existing vehicle is mounted at an angle decreased to the inside by 15° from the same line as a dashboard so as to clearly and accurately see the rear side, and a driver can actually see the rear side at an angle of 35° only. That is, vehicles traveling within the remaining angle of 40° correspond to a blind area and may not be suitably seen. Therefore, in case of changing lanes, a collision accident may inevitably occur unless the driver turns their head back to check the driving vehicle behind with the naked eye.

At present, collision accidents during lane change mostly occur due to a failure in checking vehicles traveling in a blind area, and the present invention is intended to prevent serious traffic accidents from occurring.

In order to solve the above problems, the present invention is characterized in that: instead of typical side-view mirrors on left and right sides of a vehicle, a mobile phone camera lens is installed near a site where a headlamp is mounted and which is spaced by 1.00 m in front of a site where the side-view mirror is mounted; and monitors are installed on left and right sides of a dashboard in the vehicle, wherein the mobile phone camera lens is connected to the monitors on the left and right sides by a cable, thereby enabling a driver to see the same background as a rear view projected through the mobile phone camera lens from the monitors, so that the driver can have a clear and accurate rear view through the monitors all day and night.

Further, sensor flashers may be mounted on the left and right sides of an electric vehicle by an interval of 1.00 m to 1.50 m at a height of 0.80 m from the ground and, in case of changing lanes, may generate danger indication and warning signals on the monitors if other vehicles traveling in adjacent lanes are within a dangerous range. At the same time, all situations may be recorded in the recording device of the present invention.

If the existing side-view mirror is moved to the front by 1.00 m, the driver may not suitably recognize the rear view projected through the side-view mirror due to a distance problem. However, according to the present invention, when the mobile phone camera lens is installed to a position shifted to the front by 1.00 m and is connected to the monitors installed on the left and right sides of a dashboard inside the vehicle by a cable, it is possible to pull up the rear view by 1.00 m to the front. Therefore, compared to the rear view through the side-view mirror, a wider rear view field at an angle of 60° may be clearly and accurately given and a blind area may be naturally eliminated.

According to the present invention, an electric vehicle or a rechargeable electric vehicle may be equipped with a wind power generator disclosed in Korean Patent Application No. 10-2016-0038032, which has been filed by the present applicant. Such an electric vehicle or a rechargeable electric vehicle does not need any fuel gauge or thermometer and, instead, may include: a left monitor to watch the left side, which is mounted at a position of a tachometer (RPM) located on the left side of a dashboard; and a right monitor to watch the right side, which is mounted at a position of a fuel gauge or thermometer located on the right side of the same. Herein, the tachometer (RPM) is altered into an electric tachometer (RPM), thus being mounted vertically on the same position as the existing speedometer (SPEED).

In case of switching a direction horizontally (in left and right directions), when a vehicle traveling in an adjacent lane is within a dangerous range, danger indication and warning signals may be generated by the sensor flashers which are mounted on the left and right sides of the vehicle by an interval of 1.00 m to 1.50 m at 0.80 m height from the ground, thereby calling a driver's attention to a risk. Since the turn signal lamps and sensor flashers mounted on front and back sides of the vehicle are turned on in a direction of progress, simultaneously, other drivers may correctly recognize a traveling direction of the vehicle ahead to thus prevent a collision accident from occurring. Further, even when the driver intends to change lanes to the left or right side, it is possible to gaze at front of the dashboard in the same direction as the direction of travel, thereby preventing instant eye breakaway. Consequently, the present invention has a configuration of preventing mental fatigue as well as traffic accidents.

### PRIOR ART DOCUMENT

### Patent Document

Patent Application No. KR 10-2016-0038032

### DISCLOSURE

### Technical Problem

According to the conventional methods as described above, the side-view mirrors are mounted on the left and right sides at an angle decreased to the inside by 15° from the same line as a dashboard of the vehicle, and therefore, a driver can see the rear side at an angle of 35° only relative to the dashboard. As a result, vehicles traveling within the remaining angle of 40° corresponding to a blind area may not be suitably recognized.

If a lane is changed according to the current approach, vehicles in the blind area could not be seen properly. Therefore, the driver should watch the side-view mirrors again or turn his head back to check the left and/or right sides with the naked eye. In such a case, there is a risk of collision accidents due to instant negligence of due care and attention, and the collision accident causes huge loss of life and property and entails inconvenience to many people due to traffic jam.

### Technical Solution

The present invention has been proposed to solve the above problems, and an object of the present invention is to provide a recording device with configurations of: instead of side-view mirrors mounted on a typical vehicle, a mobile phone camera lens installed on each of left and right sides where a headlamp is mounted and which is spaced by 1.00 m in front of the side-view mirror, in order to see a rear side; a left monitor installed at a site where a tachometer (RPM) is mounted and which is the left side of a dashboard of the vehicle, in order to afford the left rear view; a right monitor installed at a site where a thermometer (TEMPERATURE) and a fuel gauge (FUEL) are mounted and which is the right side of the dashboard, in order to afford the right rear view, wherein the mobile phone camera is connected to each of the monitors by a cable, thereby enabling a driver to see the same background as a rear view projected through the mobile phone camera lens from the monitors, so that the driver can have clear and accurate left and right rear views through the monitors installed inside the vehicle.

In case of changing lanes, turn signal lamps mounted on the front and rear sides as well as the sensor flashers installed on the left and right sides of the vehicle by an interval of 1.00 m to 1.50 m at a height of 0.80 m from the ground are turned on simultaneously in a direction of progress. Further, when other vehicles traveling in left and right sides (or in adjacent lanes) of the present vehicle are within a dangerous traveling range in terms of a distance or interval, danger indication and warning signals are generated on the monitors by the sensor flashers, so as to call a driver's attention to a risk and, at the same time, all situations are recorded in the recording device. Therefore, the recording device of the present invention is characterized in that a collision accident during lane change may be prevented and, if the collision accident occurs, the driver may determine who is at fault based on video images stored in the recording device.

### Advantageous Effects

According to the present invention, the recording device includes a mobile phone camera lens, monitors and sensor flashers connected by a cable, wherein all situations are stored in the recording device. Therefore, a driver may have a clear rear view without blind spots through the monitors during traveling so as to prevent collision accidents from occurring due to lane change during traveling.

Further, when the collision accident occurs during lane change, it is possible to determine who is at fault based on video images stored in the recording device, thereby accomplishing different effects such as prevention of conflicts, personnel and material loss caused by traffic accidents, etc.

### DESCRIPTION OF DRAWINGS

FIG. 1 is a plan view illustrating the recording device that consists of a mobile phone camera lens for eliminating blind spots, monitors and sensor flashers in an electric vehicle, to which the present inventive technology is applied;

FIG. 2 is a rear expanded photograph taken using the mobile phone camera lens in the recording device that consists of a mobile phone camera lens for eliminating blind spots, monitors and sensor flashers in an electric vehicle, to which the present inventive technology is applied;

FIG. 3 is a plan view illustrating separate features of the recording device that consists of a mobile phone camera lens for eliminating blind spots, monitors and sensor flashers in an electric vehicle, to which the present inventive technology is applied;

FIG. 4 is a cross-sectional view illustrating the configuration of the recording device that consists of a mobile phone camera lens for eliminating blind spots, monitors and sensor flashers in an electric vehicle, to which the present inventive technology is applied, wherein the above components are connected by a cable;

FIG. 5 is a plan view illustrating the recording device that consists of a mobile phone camera lens for eliminating blind spots, monitors and sensor flashers in an electric vehicle, to which the present inventive technology is applied, wherein the mobile phone camera lens is connected to the monitors installed on left and right sides of the dashboard by a cable;

FIG. 6 is a plan view illustrating the existing vehicle that consists of side-view mirrors to which the conventional technology is applied;

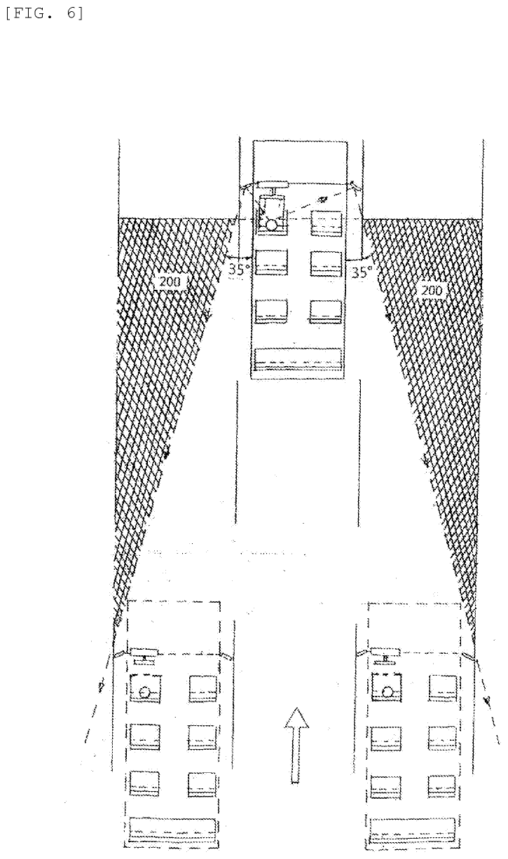

FIG. 7 is a rear expanded photograph projected through the side-view mirrors in the existing vehicle that consists of side-view mirrors to which the conventional technology is applied.

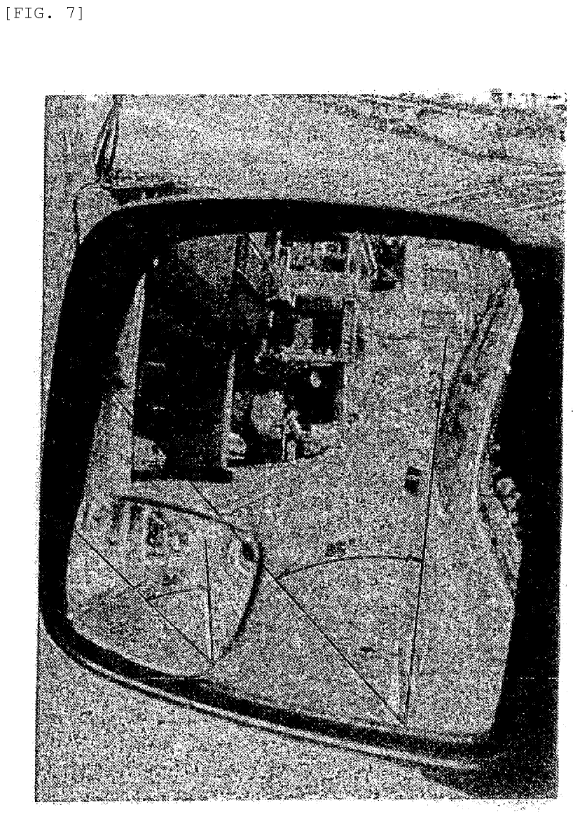

### SYMBOLS OF MAJOR PARTS IN DRAWINGS

100: Dashboard
101: Left camera lens for mobile phone
102: Right camera lens for mobile phone
103: Left monitor showing left rear view
104: Right monitor showing right rear view
105: Sensor flashers mounted on left and right sides
106: Forward detection camera
107: Backward detection camera
108: Recording device
109: Cable wire
200: Blind spots

### BEST MODE

Hereinafter, with reference to the accompanying drawings, preferred configurations and functions of the present invention in order to accomplish the above purposes will be described in detail.

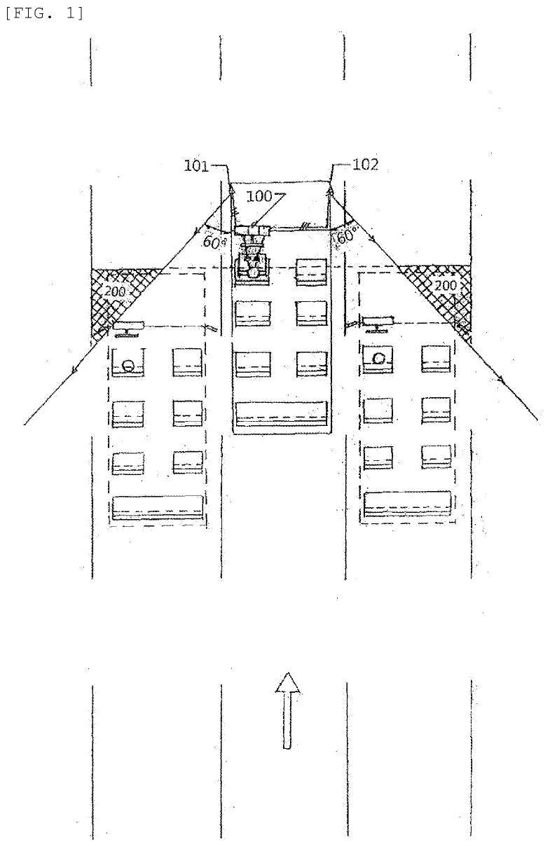

FIG. 1 is a plan view illustrating the recording device that consists of a mobile phone camera lens for eliminating blind spots, monitors and sensor flashers in an electric vehicle, to which the present inventive technology is applied.

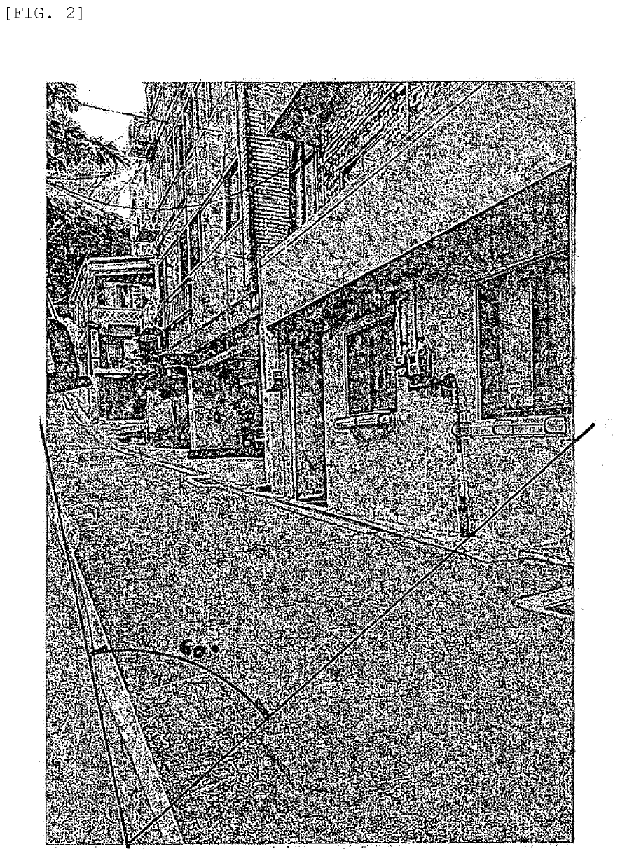

FIG. 2 is a rear expanded photograph taken using the mobile phone camera lens in the recording device that consists of a mobile phone camera lens for eliminating blind spots, monitors and sensor flashers in an electric vehicle, to which the present inventive technology is applied.

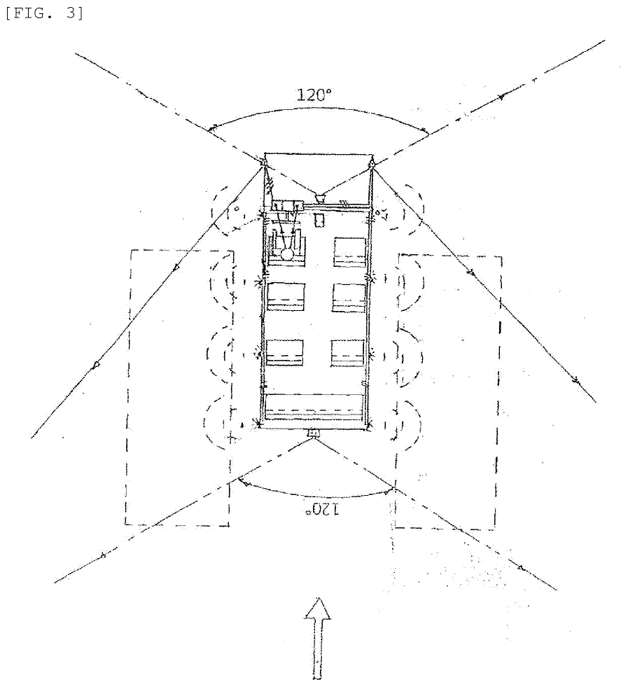

FIG. 3 is a plan view illustrating separate features of the recording device that consists of a mobile phone camera lens for eliminating blind spots, monitors and sensor flashers in an electric vehicle, to which the present inventive technology is applied.

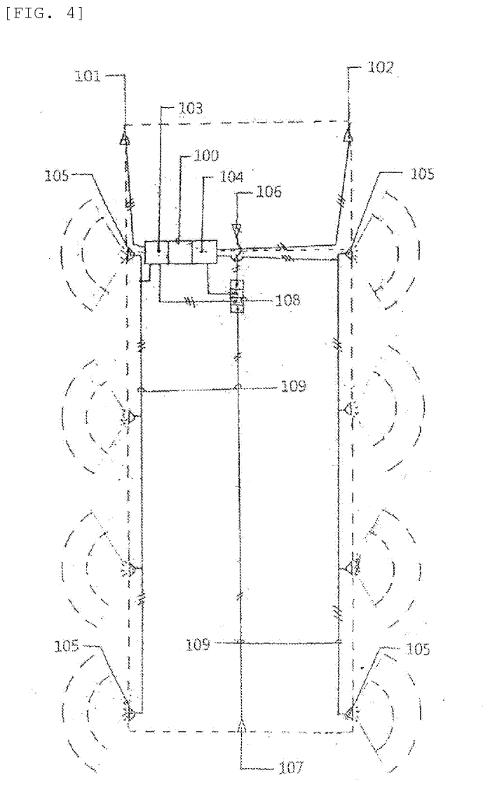

FIG. 4 is a cross-sectional view illustrating the configuration of the recording device that consists of a mobile phone camera lens for eliminating blind spots, monitors and sensor flashers in an electric vehicle, to which the present inventive technology is applied, wherein the above components are connected by a cable.

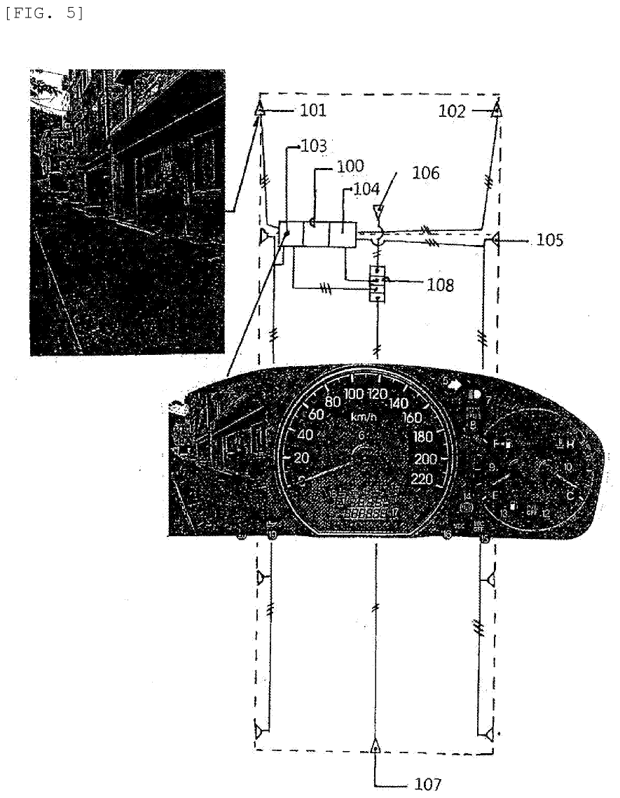

FIG. 5 is a plan view illustrating the recording device that consists of a mobile phone camera lens for eliminating blind spots, monitors and sensor flashers in an electric vehicle, to which the present inventive technology is applied, wherein the mobile phone camera lens is connected to the monitors installed on left and right sides of the dashboard by a cable.

According to the present invention, the recording device 108 is configured by connecting mobile phone camera lenses 101 and 102 for eliminating blind spots, monitors 103 and 104, sensor flashers 105 and detection cameras 106 and 107 through a cable 109 in an electric vehicle, wherein the monitors 103 and 104 installed inside the vehicle show the same background as a rear view projected through the mobile phone camera lenses 101 and 102, so that a driver may see left and right rear sides without blind spots through the monitors 103 and 104. In order to ensure safe lane change, the electric vehicle may be provided with the sensor flashers 105 on the left and right sides thereof.

The sensor flashers 105 may generate danger indication and warning signals on the monitors 103 and 104 installed inside the vehicle if other vehicles traveling in an adjacent lane are within a dangerous range in terms of a distance or interval, so as to call a driver's attention. Further, in order to ensure safe driving and lane change, the turn signal lamps in the front and rear sides of the vehicle as well as the sensor flashers 105 are turned on simultaneously to blink in the direction of progress and thus send indication to other drivers, so that other vehicles traveling in adjacent lanes may correctly recognize the driving direction of the vehicle ahead, thereby preventing a traffic accident from occurring. The recording device 108 according to the present invention may have a configuration of recording all situations around the vehicle through the detection cameras 106 and 107 during driving or parking.

The recording device configured of a mobile phone camera lens for eliminating blind spots, monitors and sensor flashers in an electric vehicle may be an optional instrument which cannot be removably attached to the electric vehicle.

Each of the mobile phone camera lenses 101 and 102 is preferably installed near a site where a headlamp is mounted and which is spaced by about 1.00 m in front of a site where the existing side-view mirror is mounted.

The left monitor 103 may be installed at a site where a tachometer (RPM) is mounted and which is the left side of a dashboard of the vehicle, while the right monitor 104 may be installed at a site where a thermometer (TEMPERATURE) and a fuel gauge (FUEL) are mounted and which is the right side of the dashboard.

The sensor flashers 105 may be mounted on the left and right sides of the vehicle by an interval of 1.00 m to 1.50 m at a height of 0.80 m from the ground. Therefore, when the driver intends to change lanes into a desired direction during driving, the turn signal lamps installed in the front and rear sides of the vehicle as well as the sensor flashers 105 are turned on to blink and, if other vehicles traveling in adjacent lanes are within a dangerous range, danger indication and warning signals are generated on the monitors 103 and 104 by the sensor flashers 105, thereby enabling the driver to safely change lanes.

The forward detection camera 106 may be provided in an upper center of a front window glass in the vehicle, in order to detect all situations occurring in front of the vehicle during driving or parking and then record the same in the recording device.

The backward detection camera 107 may be provided in an upper center of a rear window glass of the vehicle, in order to detect all background conditions of the vehicle and then record the same in the recording device.

The recording device 108 may have a configuration of four (4) channels in order to record all situations projected through the mobile phone camera lenses 101 and 102, the monitors 103 and 104, the sensor flashers 105, the forward detection camera 106 and the backward detection camera 107, simultaneously, so that the driver can identify the cause of an accident based on video images stored in the recording device if there is a collision accident or the vehicle is damaged during parking. Further, the recording device may be installed in the vicinity of a site where a gear shifter is provided and which is the central portion beside the vehicle dashboard, so as to be easily collected in case of accident.

1. A recording device provided with a camera lens for mobile phones (‘mobile phone camera lens’) to eliminate blind spots, monitors and sensor flashers in an electric vehicle, comprising:
mobile phone camera lenses (101) and (102) installed near a site where headlamps are mounted and which is spaced by 1.00 m in front of a site where side-view mirrors of a typical vehicle are mounted, in order to see the rear side, wherein the camera lenses are not removably attached but integrally mounted on the vehicle; and
monitors (103) and (104) installed on left and right sides of a dashboard of the vehicle, which are connected to the mobile phone camera lenses (101) and (102) by a cable, wherein the same background as a rear view projected through the mobile phone camera lenses (101) and (102) is seen on the monitors (103) and (104) so that a driver can have the left and right rear views from the monitors (103) and (104) without blind spots,
wherein the mobile phone camera lenses (101) and (102) as well as the monitors (103) and (104) are connected to sensor flashers (105) by a cable, so that, when the driver intends to change lanes during driving, turn signal lamps installed in the front and rear sides of the vehicle as well as the sensor flashers (105) are turned on to blink and, when other vehicles traveling in adjacent lanes are within a dangerous range, danger indication and warning signals are generated on the monitors (103) and (104) by the sensor flashers (105), thereby enabling the driver to safely change lanes,
further comprising:
a forward detection camera (106) installed to detect conditions of the vehicle during driving or parking; and a backward detection camera (107) installed to detect conditions of the vehicle during reversing or parking,
wherein the mobile phone camera lenses (101) and (102), the monitors (103) and (104), the sensor flashers (105), the forward detection camera (106) and the backward detection camera (107) are connected by a cable, in order to record all situations around the vehicle possibly occurring during driving or parking in the recording device (108), so that, in case of emergency or when a traffic accident occurs, a driver can determine who is at fault based on video images stored in the recording device.

2. The recording device according to claim 1, wherein the mobile phone camera lenses (101) and (102) are installed near a site where headlamps are mounted and which is spaced by 1.00 m in front of a site where the existing side-view mirrors are mounted, in order to see the rear side without blind spots.

3. The recording device according to claim 1, wherein the left monitor (103) is installed at a site where a tachometer (RPM) is mounted and which is the left side of the vehicle dashboard in order to afford the left rear view, while the right monitor (104) is installed at a site where a thermometer (TEMPERATURE) and a fuel gauge (FUEL) are mounted and which is the right side of the dashboard in order to afford the right rear view.

4. The recording device according to claim 1, wherein the sensor flashers (105) are mounted on the left and right sides of the vehicle by an interval of 1.00 m to 1.50 m at a height of 0.80 m from the ground, so that, when the driver intends to change lanes during driving, the turn signal lamps installed in the front and rear sides of the vehicle as well as the sensor flashers (105) are turned on to blink and, when other vehicles traveling in adjacent lanes are within a dangerous range, danger indication and warning signals are generated on the monitors (103) and (104) by the sensor flashers (105), thereby enabling the driver to safely change lanes.

5. The recording device according to claim 1, wherein the recording device (108) consists of four channels, which include: a first channel for detecting during driving straight or parking; a second channel for changing lanes when moving to a left lane during driving; a third channel for changing lanes when moving to a right lane during driving; and a fourth channel for detecting during shifting into reverse or parking, thereby recording all situations occurring around the vehicle in the recording device, so that the driver can determined who is at fault based on video images stored in the recording device (108) when there is a traffic accident or the vehicle is damaged during parking.
